(19) United States
(12) Patent Application Publication
(10) Pub. No.: US 2024/0188058 A1
(43) Pub. Date: Jun. 6, 2024

(54) TERMINAL APPARATUS, BASE STATION APPARATUS, CONTROL METHOD, AND COMPUTER-READABLE STORAGE MEDIUM FOR SUPPRESSING INFLUENCE OF INTERFERENCE ON COMMUNICATION IN ADJACENT FREQUENCY BAND

(71) Applicant: KDDI CORPORATION, Tokyo (JP)

(72) Inventors: Masahito UMEHARA, Tokyo (JP); Masaya SHIBAYAMA, Tokyo (JP); Ryoichi OGASAWARA, Tokyo (JP)

(21) Appl. No.: 18/435,602

(22) Filed: Feb. 7, 2024

Related U.S. Application Data
(63) Continuation of application No. PCT/JP2022/047922, filed on Dec. 26, 2022.

(30) Foreign Application Priority Data
Jan. 20, 2022 (JP) 2022-007242

(51) Int. Cl. H04W 72/0453; H04W 24/10; H04W 72/12; H04W 72/23

(52) U.S. Cl. CPC H04W 72/0453; H04W 24/10; H04W 72/12; H04W 72/23

(57) ABSTRACT

A terminal apparatus obtains, from a first base station apparatus that belongs to a first communication system that uses a first frequency band, setting information indicating setting of measurement in a second frequency band that is different from the first frequency band and is used for a second communication system, performs measurement of a predetermined signal transmitted from a second base station apparatus that belongs to the second communication system, based on the setting information, notifies the first base station apparatus of a result of the measurement, and communicates with the first base station apparatus in accordance with scheduling performed by the first base station apparatus based on the result of the measurement.

### CROSS-REFERENCE TO RELATED APPLICATION(S)

This application is a continuation of International Patent Application No. PCT/JP2022/047922 filed on Dec. 26, 2022, which claims priority to and the benefit of Japanese Patent Application No. 2022-007242 filed on Jan. 20, 2022, the entire disclosures of which are incorporated herein by reference.

### BACKGROUND OF THE INVENTION

### Field of the Invention

The present invention relates to a technique for suppressing the influence of interference with communication in an adjacent frequency band.

### Description of the Related Art

Commonly, in cellular communication systems, a downlink signal transmitted from a base station apparatus and moving in a direction toward a terminal apparatus and an uplink signal transmitted from a terminal apparatus and moving in a direction toward the base station apparatus are separated from each other according to time and frequency band in order to prevent those signals from interfering with each other. Such a technique makes it possible to sufficiently suppress interference in communication that is performed by a single communications carrier. In addition, interference in communication performed by a plurality of communications carriers can also be sufficiently suppressed by separating uplink and downlink from each other using a similar technique, and providing a sufficient guard band between adjacent frequency bands.

Wireless communication has come to be used for various uses, and there has been demand for flexible management of cellular communication systems. In such a situation, interference that does not conventionally occur can occur. A situation may be envisioned in which, for example, a downlink signal is transmitted through communication provided by a first communications carrier in a frequency band, and an uplink signal is transmitted through communication provided by a second communications carrier in another frequency band adjacent to the frequency band. In such a situation, the distance between terminal apparatuses can be very short, and thus, even if a guard band is provided, out-of-band components of an uplink signal of the second communications carrier can be received by a terminal apparatus of the first communications carrier with sufficient intensity, and interfere with a downlink signal. Particularly, each terminal apparatus can be configured to collectively receive signals in a certain frequency band that includes frequency bands of a plurality of communications carriers, and thus components of uplink signals of the second communications carrier from among signals that are received by a terminal apparatus of the first communications carrier become electrically dominant, and downlink signals for the terminal apparatus of the first communications carrier can be buried therein.

### SUMMARY OF THE INVENTION

The present invention provides a technique that makes it to possible to sufficiently suppress the influence of interference on communication in an adjacent frequency band, in a cellular communication system in which radio resources are flexibly managed.

According to one aspect of a present invention, there is provided a terminal apparatus, comprising: one or more processors; and one or more memories that store a computer-readable instruction for causing, when executed by the one or more processors, the one or more processors to function as: an obtaining unit configured to obtain, from a first base station apparatus that belongs to a first communication system that uses a first frequency band, setting information indicating setting of measurement in a second frequency band that is different from the first frequency band and is used for a second communication system, a measurement unit configured to perform measurement of a predetermined signal transmitted from a second base station apparatus that belongs to the second communication system, based on the setting information, a notification unit configured to notify the first base station apparatus of a result of the measurement, and a communication unit configured to communicate with the first base station apparatus in accordance with scheduling performed by the first base station apparatus based on the result of the measurement.

According to one aspect of a present invention, there is provided a base station apparatus that belongs to a first communication system that uses a first frequency band, comprising: one or more processors; and one or more memories that store a computer-readable instruction for causing, when executed by the one or more processors, the one or more processors to function as: a notification unit configured to notify a terminal apparatus of setting information indicating setting of measurement in a second frequency band that is different from the first frequency band and is used for a second communication system, a receiving unit configured to receive a result of measurement on a predetermined signal transmitted from another base station apparatus that belongs to the second communication system, the measurement having been performed by the terminal apparatus based on the setting information, and a scheduling unit configured to determine, based on the result of the measurement, whether or not to allow the terminal apparatus to transmit a signal using predetermined time resources and predetermined frequency resources included in the first frequency band, and perform scheduling of communication with the terminal apparatus based on the determination.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a communication environment.

FIG. 2 is a diagram showing an exemplary hardware configuration of a base station apparatus and a terminal apparatus.

FIG. 3 is a diagram showing an exemplary functional configuration of the terminal apparatus.

FIG. 4 is a diagram showing an exemplary functional configuration of the base station apparatus.

FIG. 5 is a diagram showing an example of flow of processing that is executed.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Communication Environment

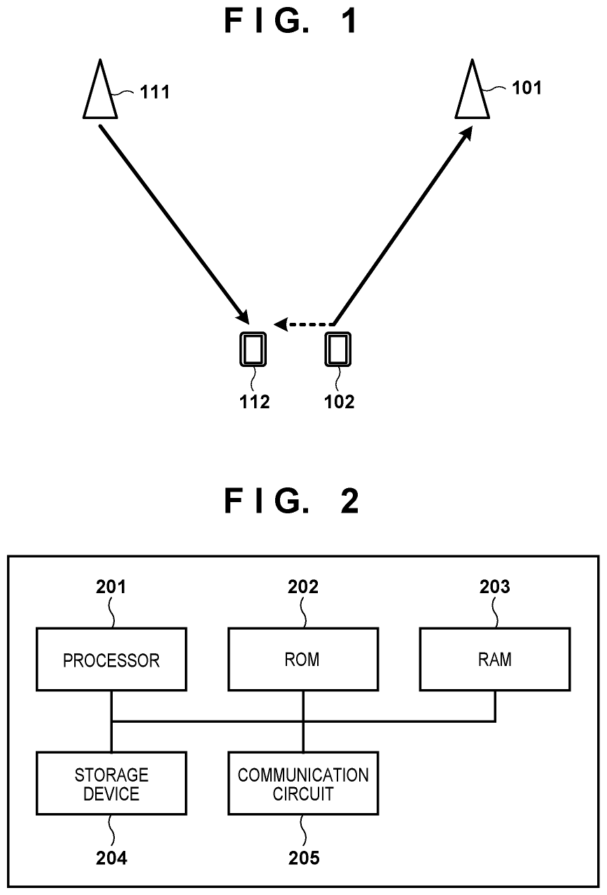

FIG. 1 shows an example of a communication environment that is considered in an embodiment of the present invention. In the environment in FIG. 1, for example, there are a plurality of wireless communication systems that each comply with a cellular wireless communication standard of 5th generation (5G) stipulated in the 3rd generation partnership project (3GPP). In this environment, for example, assume that there are a first base station apparatus 101 and a first terminal apparatus 102 that belong to a first wireless communication system provided by a first communications carrier and a second base station apparatus 111 and a second terminal apparatus 112 that belong to a second wireless communication system provided by a second communications carrier that is different from the first communications carrier. Note that this is exemplary, and a wireless communication system that operates in compliance with another standard may also be used, and there may be three or more wireless communication systems. In addition, FIG. 1 shows only one base station apparatus and only one terminal apparatus that belong to each wireless communication system, but there may be larger numbers of base station apparatuses and terminal apparatuses as a matter of course. Note that, here, an example in a case is illustrated in which there are two wireless communication systems provided by two respective communications carriers, but, for example, at least one of the wireless communication systems may be a local 5G system provided by a management entity that is different from a communications carrier. That is to say, the wireless communication systems do not need to be provided by communications carriers as long as they are provided by different managing entities.

In the present embodiment, assume that a first frequency band is used for the first wireless communication system, and a second frequency band different from the first frequency band is used for the second wireless communication system. In an example, the first frequency band and the second frequency band are frequency bands adjacent to each other, but may be frequency bands that do not have an adjacent relationship. Each of the first terminal apparatus 102 and the second terminal apparatus 112 collectively receives signals in a range of frequency band that includes both the first frequency band and the second frequency band, executes processing such as Fourier transform on the received signals, and extracts signals transmitted to the terminal apparatus, for example. At this time, for example, the second terminal apparatus 112 can execute Fourier transform with reference to a timing when a signal is received from the second base station apparatus 111.

Here, assume that frame synchronization has been established between the first wireless communication system and the second wireless communication system, and the uplink timing and the downlink timing match. In this case, even when the second terminal apparatus 112 receives a signal from the first base station apparatus 101, the signal is synchronized with a signal from the second base station apparatus 111 and the orthogonality of signals is ensured, and thus the second terminal apparatus 112 can ignore interference from the first base station apparatus 101. On the other hand, there is demand for improvement in the degree of freedom of wireless communication systems in order to meet various needs of wireless communication. For this reason, for example, it is envisioned that the uplink timing and the downlink timing are determined independently for each wireless communication system. In this case, a signal from the first terminal apparatus 102 arrives at the second terminal apparatus 112 in parallel with a signal from the second base station apparatus 111. At this time, for example, the first terminal apparatus 102 transmits a signal before a timing that serves as a reference for frames, such that the signal arrives at the first base station apparatus 101 at a predetermined timing, and thus the frame timing of the signal does not match the frame timing of a signal from the second base station apparatus 111, and orthogonality is not ensured in the second terminal apparatus 112 at the time of Fourier transform, and the interference can be too strong to ignore. Particularly, when the positions of the first terminal apparatus 102 and the second terminal apparatus 112 are close, a signal from the first terminal apparatus 102 can be received by the second terminal apparatus 112 with very high electric power. Note that, when a signal from the second base station apparatus 111 can be received by the second terminal apparatus 112 with sufficient electric power, the influence of the signal from the first terminal apparatus 102 can be made relatively small.

In light of such circumstances, in the present embodiment, the first terminal apparatus 102 can detect a signal of the second wireless communication system. In addition, when a signal of the second wireless communication system is detected by the first terminal apparatus 102 with sufficiently high power, it is envisioned that a terminal apparatus of the second wireless communication system (for example, the second terminal apparatus 112) that is present near the first terminal apparatus 102 can receive the signal of the second wireless communication system with sufficient intensity. Therefore, it is envisioned that, in such a situation, even if the first terminal apparatus 102 transmits a signal, the influence that the signal has on the second wireless communication system is sufficiently small. For this reason, it can be determined that there is no need to perform control so as to reduce the influence of interference when the first terminal apparatus 102 transmits a signal. On the other hand, when the first terminal apparatus 102 detects a signal of the second wireless communication system with predetermined power or lower, it is estimated that the strength with which a signal of the second wireless communication system will be received by a terminal apparatus of the second wireless communication system (for example, the second terminal apparatus 112) that is present near the first terminal apparatus 102 is relatively low. For this reason, it is estimated that, when the first terminal apparatus 102 transmits a signal, the influence of the signal that has on the second wireless communication system will be large. For this reason, it can be determined that there is a need to perform control so as to reduce the influence of interference when the first terminal apparatus 102 transmits a signal. Note that a case where a signal of the second wireless communication system is not detected may be handled in a similar manner to a case where power with which a signal is received is lower than or equal to the predetermined power, but a configuration may also be adopted in which such a case is handled as if the second wireless communication system is not present and it is determined that there will be no influence from a signal transmitted by the first terminal apparatus 102.

In this manner, the first terminal apparatus 102 can perform measurement on a wireless signal that is transmitted/received in a wireless communication system different from the wireless communication system to which the first terminal apparatus 102 belongs, and control is performed on whether or not to reduce interference from a signal that is transmitted from the first terminal apparatus 102, based on the measurement result. Note that control for reducing interference can include control for preventing the first terminal apparatus 102 from transmitting an uplink signal during a period during which downlink communication is performed in the second wireless communication system, for example. In addition, control for reducing interference can be causing the first terminal apparatus 102 to transmit an uplink signal using frequency resources that are sufficiently separated in the frequency region from the second frequency band of the second wireless communication system, during a period during which downlink communication is performed in the second wireless communication system, for example. That is to say, a configuration can be adopted in which, when signal receiving power of the second wireless communication system is not sufficient in a region near the first terminal apparatus 102, scheduling is performed such that power that leaks into frequency resources in which a downlink signal can be transmitted in the second wireless communication system is eliminated or is sufficiently small. Scheduling can be performed such that power of signal components that leaks into frequency resources in which a downlink signal can be transmitted in the second wireless communication system is lower than or equal to a predetermined value, by adjusting time resources and frequency resources, for example. Note that scheduling in the second wireless communication system may be performed in place of scheduling in the first wireless communication system. A configuration may also be adopted in which, for example, scheduling in the second wireless communication system is performed such that radio resources in which interference occurs with power at a certain level or higher when the first terminal apparatus 102 transmits a signal are not used for downlink communication in the second wireless communication system.

In the present embodiment, in order to perform control such as that described above, the first base station apparatus 101 notifies the first terminal apparatus 102 of setting information related to measurement on the second wireless communication system, for example, using a radio resource control (RRC) message for when the first terminal apparatus 102 is connected to the first base station apparatus 101. That is to say, the first base station apparatus 101 notifies the first terminal apparatus 102 of setting information for measuring a frequency band that is used in the second wireless communication system, using an information element (IE) in an RRC message. The first terminal apparatus 102 analyzes the RRC message, and obtains the setting information for measurement from the IE that includes information for measurement on another wireless communication system. Note that performing notification of setting information using an RRC message is exemplary, and, for example, not only a terminal apparatus in a connected state but also a terminal apparatus in a disconnected state may be notified of setting information using a broadcast signal.

When notification of setting information is performed using an RRC message, notification of the setting information can be performed using at least one of MeasObjectNR, MeasObjectCLI, and MeasReport of the RRC message, for example. In addition, a new IE that is included in an RRC message in order to perform notification of setting information for measurement on another wireless communication system (for example, a wireless communication system that is provided by another communications carrier) may be defined.

Here, the setting information can include information indicating a frequency band for which measurement is to be performed, for example. Here, the information regarding a frequency band can include information regarding the second frequency band that is used in the second wireless communication system, for example. Note that the information indicating a frequency band for which measurement is to be performed can be any information that makes it possible to specify a frequency band, such as information indicating the frequencies of the lower end and the upper end of a frequency band, an index allocated to a frequency band in advance, or the like. In addition, the setting information may particularly include information indicating a predetermined frequency that is a measurement target, from among frequency bands for which measurement is to be performed such as the second frequency band. The information indicating the predetermined frequency can include an absolute radio-frequency channel number (ARFCN), for example. In an example, NR-ARFCN of the second wireless communication system may be notified as information indicating a predetermined frequency. In addition, the setting information may include a frequency bandwidth (for example, the second frequency band) for which measurement is to be performed. In addition, the setting information can include information indicating a signal that is a measurement target. Note that the information indicating a signal that is a measurement target can be information indicating the positions of time resources and frequency resources in which the signal is transmitted, in an example. The position of the time resources may be, for example, information for directly designating time resources such as a frame number or time information, or may be information for indirectly designating time resources such as an offset value from a reference frame or time. In addition, the position of time resources may include cycle information. In addition, the position of frequency resources may be information directly designating frequency resources such as the value of a frequency or an index of a resource block, or may be information for indirectly designating frequency resources such as offset values from reference frequencies (for example, frequencies of the lower end and upper end of a frequency band). In addition, when frequency hopping of a signal that is an observation target is found, information such as a hopping pattern may be used as information indicating the position of frequency resources. Note that the setting information may be one of the above pieces of information, or combination of two or more pieces thereof. In addition, information other than the above information may also be included as setting information.

Note that a signal that is a measurement target can be a predetermined signal that is set to be periodically transmitted using predetermined frequency resources and time resources in the second wireless communication system, for example. Examples of the predetermined signal can include a synchronization signal/physical broadcast channel block (SSB) or a non cell-defined (NCD)-SSB, for example. Note that the SSB (or cell-defined (CD)-SSB) is a signal required for a system. The SSB is periodically transmitted using specific frequency resources and time resources in order to establish downlink time synchronization, or to provide system information such as a master information block (MIB). The NCD-SSB is a signal that is not required for a system, but can be configured to be periodically transmitted using specific frequency resources and time resources similarly to the SSB. In addition, in an example, the predetermined signal may be a predetermined reference signal. An existing reference signal may be used as this reference signal, or a new reference signal for a terminal apparatus of another wireless communication system to perform measurement may be defined. Note that, when a predetermined signal that is a measurement target is determined in advance, the first base station apparatus 101 does not need to notify the first terminal apparatus 102 of information indicating a signal that is a measurement target.

Note that the first base station apparatus 101 can notify the first terminal apparatus 102 of information that makes it possible to specify frequency resources and time resources in which the predetermined signal is transmitted. The first base station apparatus 101 may obtain, from the second base station apparatus 111, information regarding frequency resources and time resources in which the predetermined signal is transmitted, or may hold such information in advance by the communications carrier that provides the first wireless communication system performing presetting, for example. Note that information regarding a frequency band, information regarding a frequency bandwidth, and information regarding a frequency related to a predetermined signal such as ARFCN, which have been described above, may be used as information that makes it possible to specify frequency resources and time resources in which the predetermined signal is transmitted. That is to say, determination is performed in advance such that frequency resources and time resources in which the predetermined signal is transmitted can be specified using information regarding a frequency band, information regarding a frequency bandwidth, and information regarding a frequency such as ARFCN. Note that a configuration may also be adopted in which, for example, when the predetermined signal is an SSB and information regarding ARFCN is not obtained, the first terminal apparatus 102 performs search for each frequency band that is a measurement target, and performs processing for detecting an SSB.

The first terminal apparatus 102 performs measurement on the predetermined signal (for example, an SSB or NCD-SSB) transmitted from the second base station apparatus 111, based on the setting information obtained as described above, and notifies the first base station apparatus 101 of the measurement result. The measurement result can include information indicating power with which the predetermined signal is received, for example. In an example, when a predetermined signal that is a measurement target is a reference signal, reference signal received power (RSRP) may be used as a measurement result. In addition, SS-RSRP that is based on a synchronization signal may also be used as a measurement result. In addition, a difference value from a predetermined value of RSRP (for example, a measured value of RSRP notified in the past or a measured value of other RSRP that is to be notified along with the measurement result) may be notified. In addition, for example, information regarding a frequency such as ARFCN in a frequency band in which the predetermined signal was detected with predetermined power or lower (or with power that exceeds the predetermined power) may be notified as a measurement result. In addition, other information that makes it possible to specify a frequency band in which the predetermined signal was detected with predetermined power or lower (or with power that exceeds the predetermined power) may be notified as a measurement result.

Note that a condition (event) for performing such notification may be set. A configuration may be adopted in which, when the condition for performing notification is satisfied, the first terminal apparatus 102 notifies the first base station apparatus 101 of a measurement result. Note that the first terminal apparatus 102 may periodically perform notification, for example. Note that examples of the condition for performing notification can include a predetermined signal of the second wireless communication system having been detected with the predetermined power or lower. That is to say, a configuration can be adopted in which the first terminal apparatus 102 notifies the first base station apparatus 101 of a measurement result on condition that, when the first terminal apparatus 102 transmits a signal, the level of the influence of interference from the signal can be higher than or equal to a predetermined level. In addition, examples of the condition for performing notification may include a predetermined signal of the second wireless communication system having been detected with power that exceeds the predetermined power. That is to say, a configuration may be adopted in which the first terminal apparatus 102 notifies the first base station apparatus 101 of a measurement result on condition that, even when the first terminal apparatus 102 transmits a signal, the level of interference from the signal will be sufficiently low compared to power with which a signal from the second base station apparatus 111 is received. In addition, examples of the condition for performing notification may include expiration of a predetermined timer that was started in accordance with notification of setting information for measurement. That is to say, a configuration may be adopted in which the first terminal apparatus 102 notifies the first base station apparatus 101 of a measurement result in accordance with a certain period of time having elapsed after the setting information was obtained. Note that, for example, the condition for performing notification may be notified from the first base station apparatus 101 to the first terminal apparatus 102 along with the setting information, or may be set in advance at the time of manufacturing of the first terminal apparatus 102. In addition, the condition for performing notification may comprise one or more of the above conditions, or may include a condition other than the above conditions.

Upon receiving, from the first terminal apparatus 102, notification of a measurement result such as that described above, the first base station apparatus 101 executes scheduling of communication with the first terminal apparatus 102 based on the measurement result. The first base station apparatus 101 determines whether or not to allow the first terminal apparatus 102 to transmit a signal using predetermined time resources in which the second base station apparatus 111 transmits a signal, and predetermined frequency resources included in the first frequency band that is used for the first wireless communication system, for example. That is to say, the first base station apparatus 101 can determine, based on a measurement result, whether or not predetermined frequency resources, in which communication in the second frequency band can be interfered when the first terminal apparatus 102 transmits a signal, may be allocated to the first terminal apparatus 102. The first base station apparatus 101 can determine that the predetermined frequency resources are not to be allocated to the first terminal apparatus 102 in the above predetermined time resources when the first terminal apparatus 102 detects the predetermined signal in the second frequency band with the predetermined power or lower, for example. In this case, for example, the first base station apparatus 101 may allocate other frequency resources different from the predetermined frequency resources to signal transmission of the first terminal apparatus 102 in the predetermined time resources, or a configuration may also be adopted in which signal transmission of the first terminal apparatus 102 is not allowed during the predetermined time resources. In addition, the first base station apparatus 101 may transmit a downlink signal to the first terminal apparatus 102 during the predetermined time resources. In this manner, the first base station apparatus 101 performs scheduling such that influence of interference that signal transmission of the first terminal apparatus 102 has on the second wireless communication system is sufficiently small, and communicates with the first terminal apparatus 102 in accordance with the scheduling. Note that this is exemplary, and, for example, a configuration may also be adopted in which the first base station apparatus 101 notifies the second base station apparatus 111 of a measurement result, to prevent a signal from being transmitted during the predetermined time resources.

In the present embodiment, as described above, the first terminal apparatus 102 can perform measurement on a downlink signal of the second wireless communication system, and scheduling of the first terminal apparatus 102 is performed based on the measurement result. Accordingly, it is possible to suppress the influence that signal transmission of the first terminal apparatus 102 has on communication of the second wireless communication system (particularly, downlink communication).

### Apparatus Configuration

An exemplary hardware configuration of the first base station apparatus 101 and the first terminal apparatus 102 will be described with reference to FIG. 2. In an example, each of the first base station apparatus 101 and the first terminal apparatus 102 is configured by including a processor 201, a ROM 202, a RAM 203, a storage device 204, and a communication circuit 205. The processor 201 is a computer configured by including one or more processing circuits such as a general-purpose central processing unit (CPU) and an application specific integrated circuit (ASIC), and executes overall processing of the apparatus and the above-described processing by reading out and executing a program stored in the ROM 202 or the storage device 204. The ROM 202 is a read-only memory that stores information such as programs and various parameters related to processing that is performed by the first base station apparatus 101 and the first terminal apparatus 102. The RAM 203 functions as a work space when the processor 201 executes a program, and is a random access memory that stores temporary information. The storage device 204 is constituted by a removable external storage device and the like. The communication circuit 205 is constituted by a circuit for wireless communication of LTE or 5G, for example. Note that FIG. 2 illustrates one communication circuit 305, but the first base station apparatus 101 and the first terminal apparatus 102 can each include a plurality of communication circuits. The first base station apparatus 101 and the first terminal apparatus 102 can include wireless communication circuits for LTE and 5G and a common antenna, for example. Note that the first base station apparatus 101 and the first terminal apparatus 102 may include an antenna for LTE and an antenna for 5G separately. In addition, the first base station apparatus 101 may include a communication circuit for wired communication with another base station apparatus and network node, for example, and the first terminal apparatus 102 may include a communication circuit for another wireless communication system such as a wireless LAN. Note that the first base station apparatus 101 and the first terminal apparatus 102 may include separate communication circuits 205 respectively for a plurality of available frequency bands, or may include the communication circuit 205 that is common to at least some of the frequency bands.

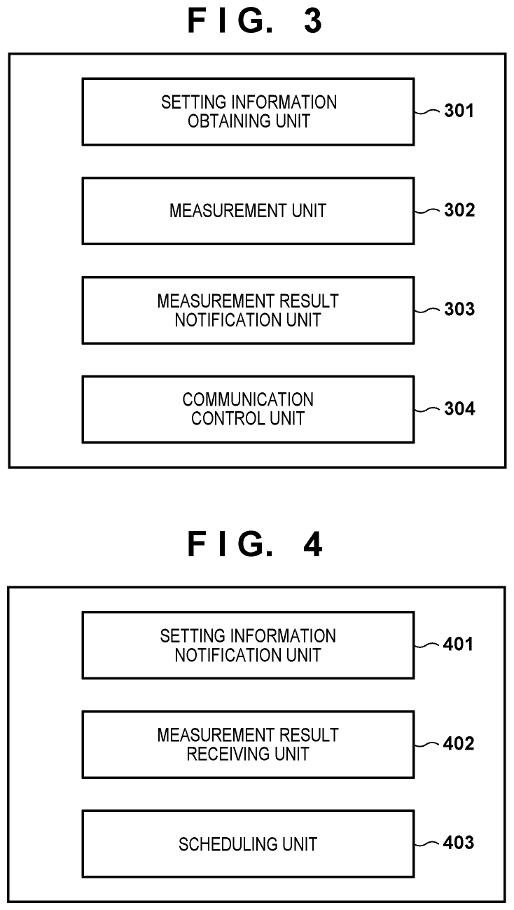

FIG. 3 is a diagram showing an exemplary functional configuration of the first terminal apparatus 102. The first terminal apparatus 102 is configured by including, as functions thereof, a setting information obtaining unit 301, a measurement unit 302, a measurement result notification unit 303, and a communication control unit 304, for example. Note that these function units can be realized by the processor 201 executing a program stored in the ROM 202 or the storage device 204, for example. Note that processing that needs to be executed by the first terminal apparatus 102 has been described above, and thus, here, only a brief overview of the functional configuration of the first terminal apparatus 102 will be given, and detailed description thereof is not repeated.

The setting information obtaining unit 301 obtains, from the first base station apparatus 101, setting information for performing measurement on a signal transmitted from the second base station apparatus 111 of the second wireless communication system that is different from the first wireless communication system to which the first terminal apparatus 102 belongs. As described above, this setting information is information for enabling the first terminal apparatus 102 to perform measurement on a predetermined signal that is periodically transmitted from the second base station apparatus 111 using predetermined frequency resources and time resources. Note that, when information regarding a predetermined signal that is transmitted from the second base station apparatus 111 is held in the first terminal apparatus 102 in advance, or when a predetermined signal can be detected by the first terminal apparatus 102 without specific information, for example, only information indicating that measurement needs to be performed on the signal from another system may be obtained as setting information. The setting information obtaining unit 301 may obtain information indicating a condition for performing notification of a measurement result along with the setting information. Note that information indicating a condition may be notified as one element of the setting information. The measurement unit 302 performs measurement on a predetermined signal (for example, SSB or NCD-SSB) transmitted from the second base station apparatus 111 based on the setting information obtained by the setting information obtaining unit 301. The measurement unit 302 measures, for example, the receiving power level of the predetermined signal. The measurement result notification unit 303 notifies the first base station apparatus 101 of a result of measurement performed by the measurement unit 302. Note that, when a condition for performing notification of a measurement result is set, the measurement result notification unit 303 notifies the first base station apparatus 101 of the measurement result at the occasion when the condition is satisfied. The communication control unit 304 performs control so as to perform communication with the first base station apparatus 101 in accordance with scheduling performed by the first base station apparatus 101 based on the measurement result.

FIG. 4 is a diagram showing an exemplary functional configuration of the first base station apparatus 101. The first base station apparatus 101 is configured by including, as functions thereof, a setting information notification unit 401, a measurement result receiving unit 402, and a scheduling unit 403, for example. Note that these function units can be realized by the processor 201 executing program stored in the ROM 202 or the storage device 204, for example. Note that processing that needs to be executed by the first base station apparatus 101 has been described above, and thus, here, only a brief overview of the functional configuration of the first base station apparatus 101 will be given, and detailed description thereof is not repeated.

The setting information notification unit 401 notifies the first terminal apparatus 102 of setting information for the first terminal apparatus 102 to perform measurement on a signal that is transmitted from the second base station apparatus 111 of the second wireless communication system different from the first wireless communication system to which the first base station apparatus 101 belongs. As described above, this setting information is information that enables the first terminal apparatus 102 to perform measurement on a predetermined signal that is periodically transmitted from the second base station apparatus 111 using predetermined frequency resources and time resources. Note that, when information regarding a predetermined signal that is transmitted from the second base station apparatus 111 is held in the first terminal apparatus 102 in advance, or when a predetermined signal can be detected by the first terminal apparatus 102 without specific information, for example, only information indicating that measurement needs to be performed on a signal of another system may be notified as setting information. In addition, the setting information notification unit 401 may obtain information indicating a condition for performing notification of a measurement result along with setting information. Note that the information indicating a condition may be notified as one element of the setting information. The measurement result receiving unit 402 receives, from the first terminal apparatus 102, a result of the first terminal apparatus 102 performing measurement on a signal from the second base station apparatus 111, based on the notified setting information. The scheduling unit 403 estimates the influence that a signal that is transmitted from the first terminal apparatus 102 has on communication of the second wireless communication system, based on the measurement result. The scheduling unit 403 determines whether or not it is allowed to allocate radio resources that may cause interference of a predetermined level to the second frequency band when the first terminal device 102 transmits a signal, to signal transmission of the first terminal device 101 in a predetermined time resource in which the second base station device 111 transmits a signal. The scheduling unit 403 performs scheduling for communication of the first terminal apparatus 102, based on the determination result. Note that these are exemplary, and a configuration may be adopted in which the first base station apparatus 101 negotiates with the second base station apparatus 111, and, during a period during which the first terminal apparatus 102 transmits a signal, the second base station apparatus 111 does not transmit a signal using frequency resources in which the influence of a signal transmitted by the first terminal apparatus 102 is at a predetermined level. That is to say, there are various methods for using a measurement result, and the scheduling unit 403 may perform scheduling of communication of the first terminal apparatus 102 in a similar manner to a normal procedure.

### Flow of Processing

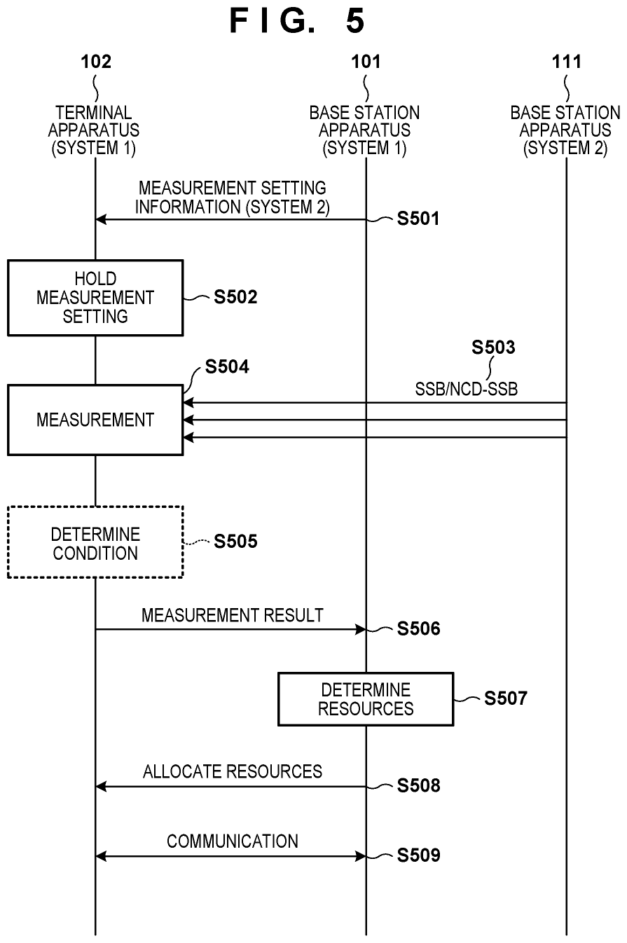

Next, an example of flow of processing that is executed by the first base station apparatus 101 and the first terminal apparatus 102 that belong to the first wireless communication system will be described with reference to FIG. 5. Note that the processing that is executed by the first base station apparatus 101 and the first terminal apparatus 102 has been described above, and thus, here, only an overview of flow of processing, and detailed description thereof is not repeated.

First, the first base station apparatus 101 transmits, to the first terminal apparatus 102, an instruction to observe a predetermined downlink signal that is transmitted in the second wireless communication system to which the first base station apparatus 101 and the first terminal apparatus 102 do not belong (or to which the first terminal apparatus 102 is not expected to be connected). At this time, the first base station apparatus 101 transmit, to the first terminal apparatus 102, setting information that enables measurement (step S501). Note that the first base station apparatus 101 transmits this instruction and setting information using an RRC message for when the first terminal apparatus 102 executes connection processing, for example, such that the first terminal apparatus 102 in the connected state performs measurement. Note that this is exemplary, and, for example, the first terminal apparatus 102 may be configured to, in an RRC_Idle state, observe a downlink signal of the second wireless communication system, store the downlink signal as a log, and perform notification of the log when the first terminal apparatus 102 enters the connected state. In this case, the first base station apparatus 101 may perform notification of setting information for obtaining the log when the first terminal apparatus 102 enters the connected state, or, may perform notification of the setting information using system information such that the first terminal apparatus 102 in the RRC_Idle state can obtain the setting information. The terminal apparatus 102 holds the setting information notified in step S501, and is ready to execute measurement that is based on the setting information (step S502).

After that, a predetermined signal is transmitted from the second base station apparatus 111 that belongs to the second wireless communication system (step S503), and the first terminal apparatus 102 performs measurement on the predetermined signal using the setting information (step S504). Note that, here, the predetermined signal is an SSB or NCD-SSB, but a signal other than these may be used as the predetermined signal. The first terminal apparatus 102 notifies the first base station apparatus 101 of the measurement result in step S504 (step S506). Note that, for example, when a condition for performing notification of a measurement result is obtained in step S501, or when such a condition is set in advance by specifications, or the like, the first terminal apparatus 102 can confirm that the condition is satisfied (step S505), and then perform notification of the measurement result (step S506).

Upon receiving the measurement result, the first base station apparatus 101 performs scheduling for communication of the first terminal apparatus 102 based on the measurement result, and performs determination on resources to be allocated for communication of the first terminal apparatus 102 (step S507). Note that, for example, when a condition for performing notification of a measurement result is set, and no measurement result is notified, the first base station apparatus 101 can determine that the condition has not been satisfied (for example, that a predetermined signal of the second wireless communication system, which has predetermined power or lower, was not detected by the first terminal apparatus 102), and execute scheduling that is based on the determination result. The first base station apparatus 101 allocates resources for transmitting a downlink signal and receiving an uplink signal, to the first terminal apparatus 102 in accordance with the determined scheduling (step S508), and performs communication in accordance with the allocated resources (step S509).

In this manner, in the present embodiment, the first terminal apparatus 102 can perform measurement on a downlink signal in the second wireless communication system to which the first terminal apparatus 102 does not belong (to which the first terminal apparatus 102 is not expected to be connected), and notify the first base station apparatus 101 (the network of the first wireless communication system) of the measurement result. Then, in a first wireless communication network, determination is performed on resources to be allocated to (particularly uplink) communication of the first terminal apparatus 102 in consideration of the influence of a signal transmitted by the first terminal apparatus 102 and interfering with a signal that is received by the second terminal apparatus 112 in the second wireless communication system. Accordingly, it is possible to flexibly manage a cellular communication system while suppressing the influence on communication of another wireless communication system that uses an adjacent frequency band, for example, and thus, it is possible to contribute to Goal 9 of Sustainable Development Goals (SDGs) lead by United Nations “Build resilient infrastructure, promote inclusive and sustainable industrialization and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal apparatus, comprising:
one or more processors; and
one or more memories that store a computer-readable instruction for causing, when executed by the one or more processors, the one or more processors to function as:
an obtaining unit configured to obtain, from a first base station apparatus that belongs to a first communication system that uses a first frequency band, setting information indicating setting of measurement in a second frequency band that is different from the first frequency band and is used for a second communication system,
a measurement unit configured to perform measurement of a predetermined signal transmitted from a second base station apparatus that belongs to the second communication system, based on the setting information,
a notification unit configured to notify the first base station apparatus of a result of the measurement, and
a communication unit configured to communicate with the first base station apparatus in accordance with scheduling performed by the first base station apparatus based on the result of the measurement.

2. The terminal apparatus according to claim 1,
wherein the obtaining unit obtains the setting information from an information element in a radio resource control (RRC) message for when the terminal apparatus is connected to the first base station apparatus.

3. The terminal apparatus according to claim 2,
wherein the information element includes at least one of MeasObjectNR, MeasObjectCLI, and MeasReport.

4. The terminal apparatus according to claim 1,
wherein the setting information includes at least one of information indicating the second frequency band, information indicating a predetermined frequency that is a measurement target in the second frequency band, information indicating a bandwidth of the second frequency band, and information for specifying the predetermined signal.

5. The terminal apparatus according to claim 1,
wherein the predetermined signal is a signal set to be periodically transmitted from the second base station apparatus using predetermined frequency resources and time resources.

6. The terminal apparatus according to claim 1,
wherein the predetermined signal includes a synchronization signal/physical broadcast channel block (SSB) or a non cell-defined (NCD)-SSB.

7. The terminal apparatus according to claim 1,
wherein the obtaining unit further obtains information indicating a condition for notifying the first base station apparatus of the result of the measurement, and
the notification unit notifies the first base station apparatus of the result of the measurement when the condition is satisfied.

8. The terminal apparatus according to claim 7,
wherein the condition includes the predetermined signal having been detected with predetermined power or lower.

9. The terminal apparatus according to claim 1,
wherein the notification unit notifies the first base station apparatus of at least one of information indicating receiving power of the predetermined signal and information regarding a frequency related to the predetermined signal, as the result of the measurement.

10. Abase station apparatus that belongs to a first communication system that uses a first frequency band, comprising:
one or more processors; and
one or more memories that store a computer-readable instruction for causing, when executed by the one or more processors, the one or more processors to function as:
a notification unit configured to notify a terminal apparatus of setting information indicating setting of measurement in a second frequency band that is different from the first frequency band and is used for a second communication system,
a receiving unit configured to receive a result of measurement on a predetermined signal transmitted from another base station apparatus that belongs to the second communication system, the measurement having been performed by the terminal apparatus based on the setting information, and
a scheduling unit configured to determine, based on the result of the measurement, whether or not to allow the terminal apparatus to transmit a signal using predetermined time resources and predetermined frequency resources included in the first frequency band, and perform scheduling of communication with the terminal apparatus based on the determination.

11. The base station apparatus according to claim 10,
wherein the notification unit performs notification of the setting information using an information element in a radio resource control (RRC) message for when the terminal apparatus is connected to the base station apparatus.

12. The base station apparatus according to claim 11,
wherein the information element includes at least one of MeasObjectNR, MeasObjectCLI, and MeasReport.

13. The base station apparatus according to claim 10,
wherein the setting information includes at least one of information indicating the second frequency band, information indicating a predetermined frequency that is a measurement target in the second frequency band, information indicating a bandwidth of the second frequency band, and information for specifying the predetermined signal.

14. The base station apparatus according to claim 10,
wherein the predetermined signal is a signal set to be periodically transmitted from another base station apparatus that belongs to the second communication system, using predetermined frequency resources and time resources.

15. The base station apparatus according to claim 10,
wherein the predetermined signal includes a synchronization signal/physical broadcast channel block (SSB) or a non cell-defined (NCD)-SSB.

16. The base station apparatus according to claim 10,
wherein the notification unit further performs notification of information indicating a condition for the terminal apparatus to notify the base station apparatus of the result of the measurement.

17. The base station apparatus according to claim 16,
wherein the condition includes the predetermined signal having been detected with predetermined power or lower.

18. The base station apparatus according to claim 10,
wherein the result of the measurement includes at least one of information indicating receiving power of the predetermined signal and information regarding a frequency related to the predetermined signal.

19. A control method that is executed by a terminal apparatus, comprising:
obtaining, from a first base station apparatus that belongs to a first communication system that uses a first frequency band, setting information indicating setting of measurement in a second frequency band that is different from the first frequency band and is used for a second communication system;
performing measurement of a predetermined signal transmitted from a second base station apparatus that belongs to the second communication system, based on the setting information;
notifying the first base station apparatus of a result of the measurement; and
communicating with the first base station apparatus in accordance with scheduling performed by the first base station apparatus based on the result of the measurement.

20. A control method that is executed by a base station apparatus that belongs to a first communication system that uses a first frequency band, comprising:
notifying a terminal apparatus of setting information indicating setting of measurement in a second frequency band that is different from the first frequency band and is used for a second communication system;
receiving a result of measurement on a predetermined signal transmitted from another base station apparatus that belongs to the second communication system, the measurement having been performed by the terminal apparatus based on the setting information; and
determining, based on the result of the measurement, whether or not to allow the terminal apparatus to transmit a signal using predetermined time resources and predetermined frequency resources included in the first frequency band, and performing scheduling of communication with the terminal apparatus based on the determination.

21. A non-transitory computer-readable storage medium that stores a program for causing a computer included in a terminal apparatus to execute a control method, wherein the control method comprises:
obtaining, from a first base station apparatus that belongs to a first communication system that uses a first frequency band, setting information indicating setting of measurement in a second frequency band that is different from the first frequency band and is used for a second communication system;
performing measurement of a predetermined signal transmitted from a second base station apparatus that belongs to the second communication system, based on the setting information;
notifying the first base station apparatus of a result of the measurement; and
communicating with the first base station apparatus in accordance with scheduling performed by the first base station apparatus based on the result of the measurement.

22. A non-transitory computer-readable storage medium that stores a program for causing a computer included in a base station apparatus that belongs to a first communication system that uses a first frequency band to execute a control method, wherein the control method comprises:
notifying a terminal apparatus of setting information indicating setting of measurement in a second frequency band that is different from the first frequency band and is used for a second communication system;
receiving a result of measurement on a predetermined signal transmitted from another base station apparatus that belongs to the second communication system, the measurement having been performed by the terminal apparatus based on the setting information; and
determining, based on the result of the measurement, whether or not to allow the terminal apparatus to transmit a signal using predetermined time resources and predetermined frequency resources included in the first frequency band, and performing scheduling of communication with the terminal apparatus based on the determination.
